(19) United States
(12) Patent Application Publication
(10) Pub. No.: US 2025/0325433 A1
(43) Pub. Date: Oct. 23, 2025

(54) Soft Robotic Device, Kit and System for Limb Rehabilitation

(71) Applicants: National University of Singapore, Singapore (SG); Roceso Technologies Private Limited, Singapore (SG)

(72) Inventors: Fanzhe LOW, Singapore (SG); Jeong Hoon Lim, Singapore (SG); Chen Hua Yeow, Singapore (SG); Hong Kai Yap, Singapore (SG); Jane Lu Wang, Singapore (SG)

(21) Appl. No.: 19/183,839

(22) Filed: Apr. 19, 2025

(30) Foreign Application Priority Data
Apr. 19, 2024 (SG) 10202401149X

(51) Int. Cl. A61H 1/02; A61H 9/00; B25J 9/00; B25J 9/14; B25J 13/08

(52) U.S. Cl. CPC A61H 1/0266; A61H 9/0092; B25J 9/0006; B25J 9/142; B25J 13/085; B25J 13/088; A61H 2201/0103; A61H 2201/1238; A61H 2201/1642; A61H 2201/1669; A61H 2201/5007; A61H 2201/5061; A61H 2201/5084; A61H 2209/00

(57) ABSTRACT

A lower or an upper limb rehabilitation system is described. The limb rehabilitation system includes assisted-ankle or assisted-wrist rehabilitation device (300) and an intermittent pneumatic compression (IPC) device (305). The limb rehabilitation device (300) is made up of soft extension actuator assemblies (410) that are operable to minimise joint contracture, while the IPC device (305) is operable to increase venous blood flow in at-risk patients to help prevent deep vein thrombosis and pulmonary embolism. For lower limb rehabilitation, the rehabilitation device (300) provides assisted ankle dorsiflexion-plantarflexion and eversion-inversion to improve users' ankle mobility.

### CROSS-REFERENCE TO RELATED APPLICATION

The instant application claims priority to Singapore Patent Application Serial No. 10202401149X filed on Apr. 19, 2024, the entire specification of which is expressly incorporated herein by reference.

### FIELD OF THE INVENTION

The present invention relates generally to soft robots or soft linear actuators with integrated sensors for lower or upper limb rehabilitation to minimize wrist or ankle contracture. In addition, the device and system can also be used for intermittent compression of calf muscles to prevent deep vein thrombosis and pulmonary embolism.

### BACKGROUND OF THE INVENTION

In the area of ankle rehabilitation, known technologies include continuous passion motion (CPM) devices, exercise peddlers and other similar devices, wherein these devices all have the aim at mobilizing the lower limbs or ankle joints. For these devices, they are mainly used at rehabilitation centers and require inpatients to be transferred to the centers for therapy or outpatients to be available at the rehabilitation centers via appointment.

The invention device differentiates from the devices of these known technologies since it is portable and easy to use. Therefore, it is possible to bring the invention device to the patients, either at the placement of the ward or straight to their home environment. Furthermore, the invention device allows for acute intervention following immobility where patient recovery is optimised by bringing rehabilitation of the ankle or wrist right to the application at the ward or bedside—and this is only possible since the invention device is portable and lightweight.

It can thus be seen that there exists a need for a readily available device that can provide dual functions of both preventing deep vein thrombosis (DVT) and joint contracture, where long term immobility is one of the reasons for these medical complications. Therefore, this invention device aims to overcome the disadvantages of the existing prior art.

In addition, by bringing the combination of soft robotic device with intermittent pneumatic compression (IPC) implementation straight to the patient bed for ankle or wrist rehabilitation, this invention maximises outcome of rehabilitation in all aspects of patient recovery.

### SUMMARY OF THE INVENTION

The following presents a simplified summary to provide a basic understanding of the present invention. This summary is not an extensive overview of the present invention and is not intended to identify key features of the invention. Rather, it is to present some of the inventive concepts of this invention in a generalised form as a prelude to the detailed description and claims that are to follow.

Soft actuator devices are manufactured from soft materials (elastomers, gels, liquids, etc.). These soft actuator devices are useful in that their sizes and shapes can be easily changed to suit an electrical drive, chemical drive, pneumatic drive, magnetohydrodynamic drive, or hydraulic drive. Further, since a low-rigidity elastomer material is used for forming these devices (Young's modulus is less than 10 MPa), these devices are easily deformed in response to an external force. Due to these qualities, soft actuator devices can perform functions that are difficult to perform using hard metallic components. Its function is, for example, safe interaction with soft biological tissues.

Utilizing soft robotic technology, this invention relates to a Venous Assistance and Contracture Management (VACOM) system that can (i) apply intermittent pneumatic compression (IPC) to assist venous blood flow back to the heart in at-risk patients. This will help reduce deep vein thrombosis (DVT) and pulmonary embolism and (ii) provide assisted ankle dorsiflexion-plantarflexion and eversion-inversion using soft pneumatic actuators to improve patients' ankle mobility. This can also be adapted for wrist rehabilitation. A notable feature of this invention is that the device combines intermittent pneumatic compression (IPC) with ankle/wrist mobilization. This invention is thus desirable to minimise DVT and to rehabilitate ankle/wrist mobilization. In other words, the aim is to reduce the risk of immobile patients, such as stroke patients staying in hospitals or nursing homes, contracting DVT and ankle or wrist joint contracture. The invention device is useful to provide early rehabilitation intervention on immobile patients at the acute stage. Another application will be for home-based rehabilitation and nursing care following discharge from hospitals of these immobile patients.

The invention allows for pneumatic actuation or synchronization, for example intermittent calf compression and ankle or wrist mobilization. This is advantageous because it allows end-users to receive more robust rehabilitation as it imitates the natural way for a human to prevent DVT and ankle or wrist joint contracture.

In one embodiment, the invention provides for ankle mobilization via expansion-induced dorsiflexion. This is beneficial as ankle mobilization is to provide assisted ankle exercise while the users/patients, in particular the elderly, are recovering on their beds. This maximizes the effective therapeutic time each end-user receives per day so as to improve the rate of recovery as well as to prevent medical complications due to immobility.

The invention uses soft and compliant actuators, therefore reduces the risk of injuries to the end-users caused by movement of the actuators, for example when there is resistance in the foot during assisted ankle exercise.

The invention allows for ankle/wrist kinetics and kinematics sensing. This added sensing capability allows for real-time feedback of the limb mobilization so end-users who are at the hospital can track the compliance and progress of rehabilitation.

The invention device is lightweight and portable. Being lightweight, the intended users such as the nurse or the patients/elderly caregivers can bring the device to the end-users, for exampled, to be applied to the leg for assisted ankle mobilization.

The invention is easy to use, specifically for intended users who are likely medical professionals, caregivers, and patients. This minimises any operating issues that these users face such as the donning of the device on the limb or operating the electronic setup to control the assisted-limb exercise, such as at the ankle or wrist.

As the invention allows for pressure recycling, in the case of alternate control of the IPC and assisted-limb rehabilitation devices, this reduces total power consumption where air from the assisted-limb rehabilitation actuators can be used to inflate the IPC device and vice versa.

The present VACOM is constituted by the above IPC and assisted-limb rehabilitation devices. The invention also comprises remote control of multiple VACOM devices. According to an embodiment of the invention, this can be implemented by using a central console to allow for a single hospital user to control device parameters to several VACOM devices, as well as to gather consolidated data from these several devices.

In one embodiment, the present invention provides a soft robotic device for limb rehabilitation, comprising: an extension actuator disposed in an actuator pouch; braces for coupling two ends of the actuator pouch across a joint of a limb; a sensor for detecting movement at the joint of the limb; and a controller to receive input from the sensor and to output a signal to actuate the extension actuator to dorsiflex or plantarflex the joint.

In another embodiment, the present invention provides a soft robotic device for limb rehabilitation, comprising: two extension actuators disposed side-by-side in an actuator pouch; a sensor with a plurality of states based on a respective plurality of movement phases of a joint limb; a controller in communication with the sensor to receive input from the sensor and to output signals to actuate the two extension actuators; and braces for coupling ends of the actuator pouch across a joint at the limb; wherein the soft robotic device is operable to perform one of the following: when both extension actuators are simultaneously inflated to perform joint dorsiflexion; when both extension actuators are simultaneously deflated to perform joint plantarflexion; or when either extension actuator is inflated while the other is deflated to perform joint eversion or inversion.

In one embodiment, the extension actuators are inflatable by pneumatic pressure.

In another embodiment, the sensor is configured by an inertial measurement unit sensor which has multiple axes for joint kinematics and kinetics sensing.

In another embodiment, the sensor is configured by a load cell which can measure the load applied to the joint according to joint stiffness.

In another embodiment, the soft robotic device further comprises an intermittent pneumatic compression (IPC) device which is attachable onto an arm muscle or a calf muscle, wherein the IPC is operable to minimize deep vein thrombosis or pulmonary embolism.

The invention also provides for a kit for limb rehabilitation, comprising: a soft robotic device as described above, a pump for selectively inflating and deflating the extension actuators and/or IPC devices; a control box for controlling the pump; a sensor for monitoring the movements of the joint at the limb; a pouch to contain the extension actuators; a foot brace; and a knee brace; wherein the soft robotic device is configured to synchronise inflation or deflation of the extension actuators and the IPC devices to simultaneously or alternatively perform joint rehabilitation exercises.

In one embodiment, the IPC devices are arranged in a series for lower limb rehabilitation.

In another embodiment, the soft robotic device and the IPC devices are controllable independently.

The invention also provides a system for limb rehabilitation comprising: a kit of components or kits thereof as mentioned above, a central console unit operable to receiving data from each kit of components and operable to control each component of the kit individually or together.

In one embodiment, the IPC devices are operable intermittently and, in a sequence, moving away from the ankle or wrist.

In another embodiment, the extension actuators or IPC devices are made of flexible elastomers, fabrics, textiles, or any combinations thereof.

### BRIEF DESCRIPTION OF THE DRAWINGS

This invention will be described by way of non-limiting embodiments of the present invention, with reference to the accompanying drawings, in which:

FIG. 1 illustrates a “fish bone” extension actuator element according to an embodiment of the present invention;

FIG. 2 illustrates a bellow extension actuator element according to another embodiment of the present invention;

FIGS. 3A and 3B illustrate views of a lower limb assisted ankle rehabilitation device using extension actuators and intermittent pneumatic compression (IPC) devices according to an embodiment of the present invention;

FIG. 4 illustrates the above extension actuators and an actuator pouch according to an embodiment of the present invention;

FIGS. 5A and 5B illustrate exploded views of the above extension actuators according to an embodiment of the present invention;

FIG. 6 illustrates components of a VACOM device according to an embodiment of the present invention;

FIG. 7 illustrates a simulated application of the VACOM device according to an embodiment of the present invention;

FIG. 8 illustrates an exploded view of the above wearable extension actuators according to an embodiment of the present invention;

FIG. 9 illustrates a flowchart of an application of the IPC or limb rehabilitation devices according to an embodiment of the present invention;

FIGS. 10A and 10B illustrate possible control scenarios synchronizing or actuating of the extension actuators and the IPC devices according to an embodiment of the present invention;

FIG. 11 illustrates a concept of pneumatic air pressure recycling according to an embodiment of the present invention; and

FIG. 12 illustrates a concept of a central console unit controlling multiple sets of VACOM devices according to an embodiment of the present invention.

### DETAILED DESCRIPTION OF THE INVENTION

One or more specific and alternative embodiments of the present invention will now be described with reference to the attached drawings. It shall be apparent to one skilled in the art, however, that this invention may be practised without such specific details. Some of the details may not be described at length so as not to obscure the invention.

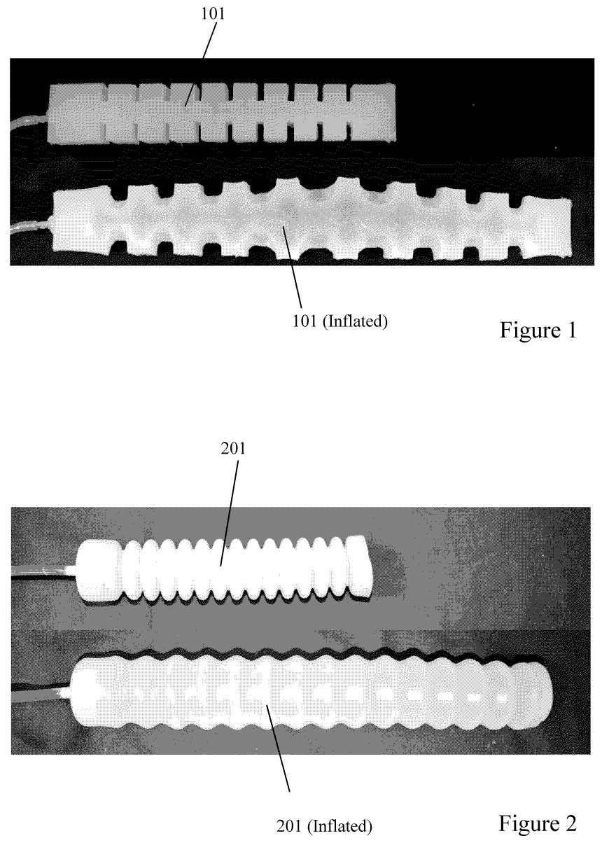

In an embodiment of the invention, compliant soft extension actuators 101, 201 are used and depicted in FIGS. 1 and 2.

Components of the invention include a Venous Assistance and Contracture Management (VACOM) system, which is deployed with these soft inflatable extension actuators 101, 201. FIG. 1 shows, according to an embodiment of the invention, a soft inflatable extension actuator 101 being a single plane symmetrical fish-bone configuration before being inflated. When inflated with air, the soft inflatable extension actuator 101 is extended substantially axially.

Another embodiment of the invention as illustrated in FIG. 2 is a soft inflatable actuator 201 having a circular cross sectional (of dual planes of symmetry) is formed in a bellow configuration. When inflated the soft inflatable extension actuator 201 works in a similar manner as the above fish-bone actuator 101.

The inflatable extension actuator 101, 201 can be molded, 3D printed or casted or made by any other forms of manufacture. The materials of the extension actuators can be any variants of a polymer that allow for the extension actuators to stretch and retract substantially axially. The advantage of using such soft materials is that the actuators are mechanically compliant when applied on a human body.

The invention includes an application for assisted limb rehabilitation, such as ankle flexing of a lower limb. In this application the extension actuator 101, 201 is configured as an extension actuator assembly 410 as seen in FIG. 4. Two similar or dual extension actuators 101, 201 are simultaneously inflated or deflated, the device helps to perform assisted ankle dorsiflexion or plantarflexion, respectively. In one embodiment, two extension actuators 101, 201 are each assembled inside an actuator pouch 401.

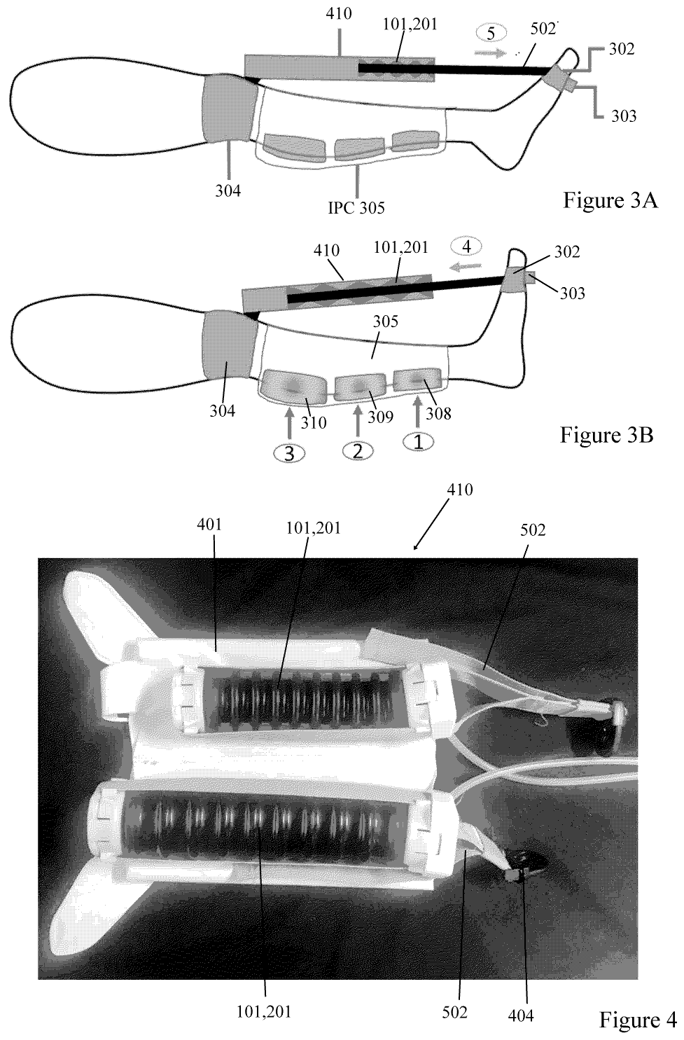

FIGS. 3A-3B depict a lower limb assisted-ankle rehabilitation device 300 comprising two actuators 101, 201, a foot brace 302, a sensor 303 and a knee brace 304. In another embodiment, an Intermittent Pneumatic Compression (IPC) device 305 is made up of three calf pouches 308, 309, 310. The assisted-ankle rehabilitation device 300 and the IPC device 305 make up a VACOM device 600. In FIG. 3B, arrows 1, 2, 3 represent the sequential inflation of the calf pouches 308, 309, 310 to promote blood flow from the foot back to the body, i.e. starting from the lower calf pouch 308 and sequentially to the upper calf pouch 310 in a proximal direction away from the foot. Arrow 4 at the extension actuator assembly 410 shows a direction of a direct axial force where pneumatic inflation of the extension actuator assemblies 410 result in ankle dorsiflexion. Deflation of the extension actuator assemblies 410 guides the foot into plantarflexion, as shown by Arrow 5.

FIG. 4 shows the extension actuator assembly 410 according to an embodiment of the invention. As shown in FIG. 4, two extension actuator assemblies 410 are configured inside an actuator pouch 401. When inflated the extension actuator assemblies 410 extend to pull on the foot brace 302 against the knee brace 304 to promote positive pressure-induced dorsiflexion. When inflation is released, the extension actuator assemblies 410 deflate to guide plantarflexion of the foot (i.e. where the extension actuator assemblies return to their uninflated shape at atmospheric pressure). In another configuration, the extension actuator assemblies can be vacuum-assisted to speed up vacuum-induced deflation. On the other hand, when either of the dual extension actuator assemblies 410 is inflated (without inflating the actuator assembly beside it), the assisted-ankle rehabilitation device 300 is arranged to perform assisted-ankle eversion or inversion.

An intended application will be for use in an acute rehabilitation of limbs of an immobile patient who has medical conditions, such as stroke or paralysis. The assisted-ankle rehabilitation devices 300 can be attached to the lower limb of the end-users/patients in the ward beds to allow assisted-ankle exercise during their resting time.

Another application of the assisted-ankle rehabilitation device 300 is to allow immobile end users to bring the device back for home therapy, where the intended users such as caregivers can apply the device to the end-users. As seen from FIGS. 3A-3B, the VACOM device 600 is also configured to implement sensors for real-time tracking of foot mobilization by placing the sensor 303 around the base of the foot. A potential sensor is an inertial measurement unit (IMU) sensor, which can track multiple axes of foot kinematics and kinetics sensing. Another possible sensor is a load cell, which can be used to adjust the load applied to the foot according to the joint stiffness.

The assisted-ankle rehabilitation device 300 will now be described in relation to FIG. 4 which depicts the extension actuator assemblies 410.

Two extension actuator assemblies 410 are located inside one actuator pouch 401. FIG. 4 shows the actuator pouch 401 is opened up to reveal two extension actuator assemblies 410. FIG. 4 shows the concept of inflation of the extension actuator assembly 410 to pull during pressure-induced dorsiflexion, where a buckle 404 connected to an associated foot brace 302, is arranged to flex an ankle into dorsiflexion. It is also possible that one extension actuator assembly 410 is inside one actuator pouch 401.

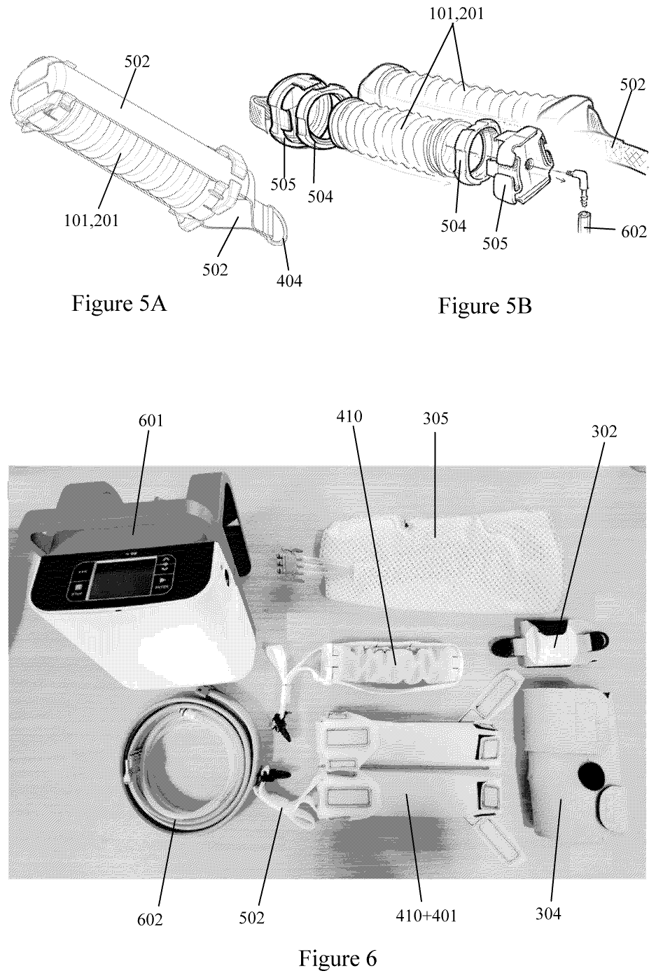

FIGS. 5A-5B show construction of the soft pneumatic extension actuator assembly 410, as shown, a strap 502 is looped around the extension actuator assembly 410 with two ends of the strap being terminated at a buckle 404. FIG. 5B is an exploded view showing each end of the extension actuator 101, 201 is open. Each open end is then connected at a terminal ring 504 and a terminal cap 505. The terminal ring 504 is sealingly connected to the respective open end of the extension actuator 101, 201, whilst the terminal ring 504 and the terminal cap 505 are also sealingly connected. Preferably, the terminal rings 504 and the terminal caps 505 are provided to allow quick connection and disconnection of the extension actuator assembly 410.

As described above, the VACOM device 600 (constituted by the limb rehabilitation device 300 and the IPC device 305) includes soft materials for the manufacturing of the components such that the VACOM device obtained is lightweight and portable. In the components shown in FIG. 6, other than the extension actuator assemblies 410 which are made of polymers and a pneumatic control box 601, the other components are made of either fabric, textiles, or any combinations of the aforementioned materials, to give this wearable invention VACOM device 600 with a total weight of preferably less than 1 kg.

FIG. 6 shows the components of the VACOM device 600 include the pneumatic control box 601, some pneumatic tubings 602, the Intermittent Pneumatic Compression (IPC) device 305, two actuator pouches 401 each enclosing a pair of extension actuator assemblies 410. The foot brace 302 and the knee brace 304. The actuator pouch 401 containing one actuator assembly 410 or a pair of extension actuator assemblies 410, the foot brace 302 and the knee brace 304 make up the wearable assisted-ankle rehabilitation device 300.

Prior to bringing the VACOM, IPC and the assisted-ankle rehabilitation devices to the end-user or patient, usually two sets of assisted-ankle rehabilitation devices 300 and IPC devices 305 are prepared. To use the ankle rehabilitation device 300, the knee brace 304 and the foot brace 302 are first worn on the patient. Following which, the actuator assemblies 410 are connected to the respective knee brace 304 via Velcro straps and to the respective foot brace 302 via the buckles 404. Naturally other forms of attachments besides Velcro and buckles can also be used. Adjustments can be made at the foot brace 302 and/or the knee brace 304 to suit different patient anthropometric parameters.

Since the direct users of the above devices 300, 305, 600 are likely medical professionals/caregivers/patients, the invention system is easy to use. This system is configured so that it minimises any operating issues users will face while using the ankle rehabilitation, the IPC and the VACOM devices. This means attaching the invention devices 300, 305, 600 on the lower limb as well as operating the pneumatic control box 601 to initiate assisted-ankle exercise can be easily executed. With the extension actuator assemblies 410 being pre-installed in the actuator pouches 401, users just have to follow a 4-steps approach to attach the invention devices 300, 305, 600 on the patient before the extension actuator assemblies can be used for limb mobilization and the IPC be used to reduce deep vein thrombosis (DVT) and pulmonary embolism. The total needed time for a new user to be able to attach or remove the invention devices from the intended end-user can be as fast as two minutes. However, this invention is not so limited by these 4 steps and the two minutes of time needed.

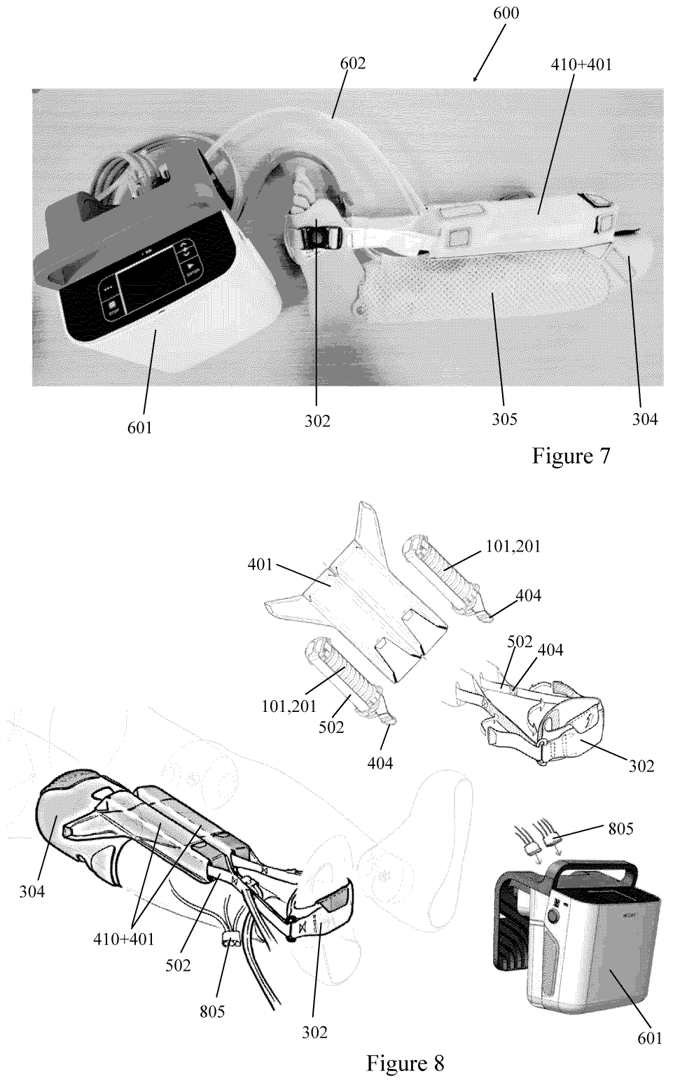

FIG. 7 illustrates the VACOM device 600 worn on the leg with the actuator assemblies 410 located inside the actuator pouch 401 being connected to the knee brace 304 and the foot brace 302. The IPC device 305 is attached to the calf muscles. The pneumatic control box 601 for the activation of the exercise cycles is connected via pneumatic tubings 602 to the assisted- ankle rehabilitation device 300 and the IPC device 305. A visual display interface and buttons for turning on/off the VACOM device 600 are located on the pneumatic control box 601. In the ward setting, the pneumatic control box 601 can be hung on an edge of a trolley or ward bed. As described above, the knee brace 304 is first worn, then the foot brace 302, before attaching the actuator assemblies 410 to the knee brace and foot brace, and connecting the pneumatic tubings 602 between the extension actuator assemblies 410 and IPC devices 305 to the pneumatic control box 601.

FIG. 8 shows the wearable the assisted-ankle rehabilitation device 300 is donned on a lower limb. An exploded view of the components shows the foot brace 302, the actuator assemblies 410, the strap 502 and the actuator pouch 401. The exploded view also shows tubing connectors 805 for plugging the pneumatic tubings 602 to the pneumatic control box 601.

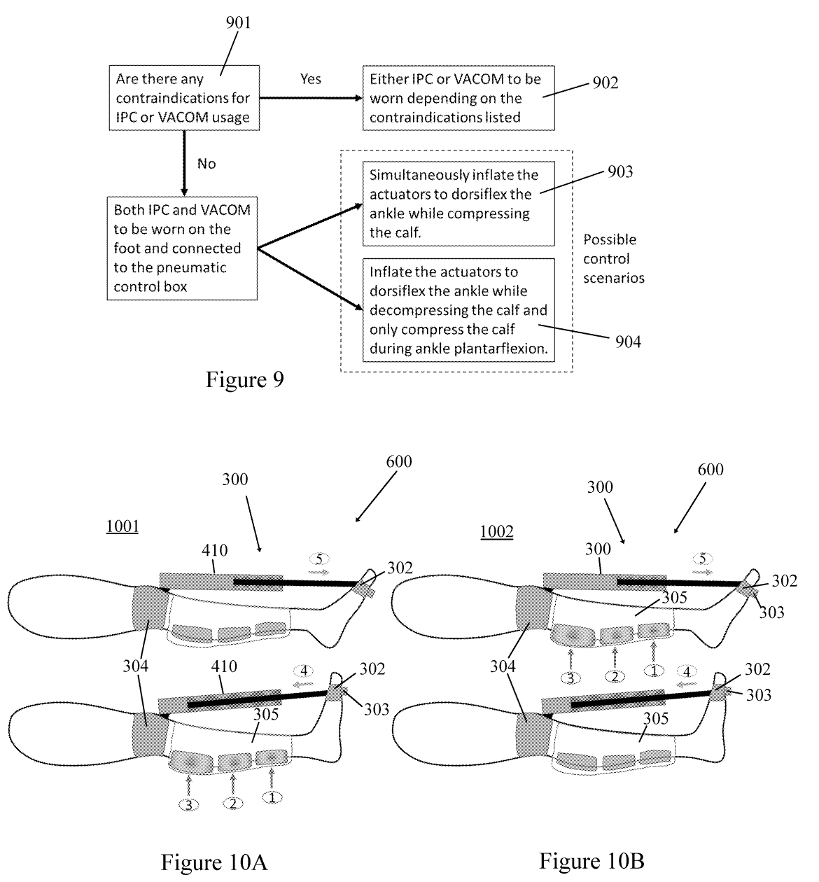

The pneumatic actuation or synchronization of the assisted-ankle rehabilitation device 300 and the IPC device 305 will now be described in relation to FIGS. 9 and 10A-10B.

One of the novel features of this invention is the implementation of the VACOM device 600 where the assisted-ankle rehabilitation device 300 and the IPC device 305 are applied on a patient, for example laying at a ward bed. The following are potential pneumatic actuation or synchronization scenarios that can be applied by users through a single pneumatic control box 601.

FIG. 9 is a flowchart of the intended application of the assisted-ankle rehabilitation device 300 and the IPC 305 constituting the VACOM device 600 with separate control scenarios for pneumatic actuation or synchronization. First step is to establish, in step 901, whether there are any contraindications for the use of both the assisted-ankle rehabilitation device 300 and the IPC device 305. If there are contraindications, then either the rehabilitation device 300 or the IPC device 305 is selected in step 902. If there are no contraindications, then both the rehabilitation device 300 device and the IPC device 305 can be worn on the user (for example, on the foot of a user), thereby the VACOM device 600 is operable to simultaneously dorsiflex, in step 903, the ankle and compress the calf muscles by varying the parameters of the pneumatic control box 601. In another mode of operation, for example the extension actuator assemblies 410 are inflated to dorsiflex the ankle whilst decompressing the IPC device 305, and only operate the IPC device 305 during ankle plantarflexion, as in step 904. Either the rehabilitation device 300 or the IPC 305 can be disconnected should there be a need, such as an occurrence of any contraindications during use, so that only one of the rehabilitation device 300 or IPC device 305 will be operable to either flex the foot or to compress the calf muscles.

FIGS. 10A-10B depict the above two possible control modes of operating the assisted-ankle rehabilitation device 300 and the IPC device 305.

As shown in FIG. 10A, the first mode 1001 is simultaneous dorsiflexion of the ankle and sequential compression of the calf muscles with the IPC device 305. The second mode 1002 is to deflate the extension actuator assemblies 410 and sequentially compressing the calf muscles during ankle plantarflexion.

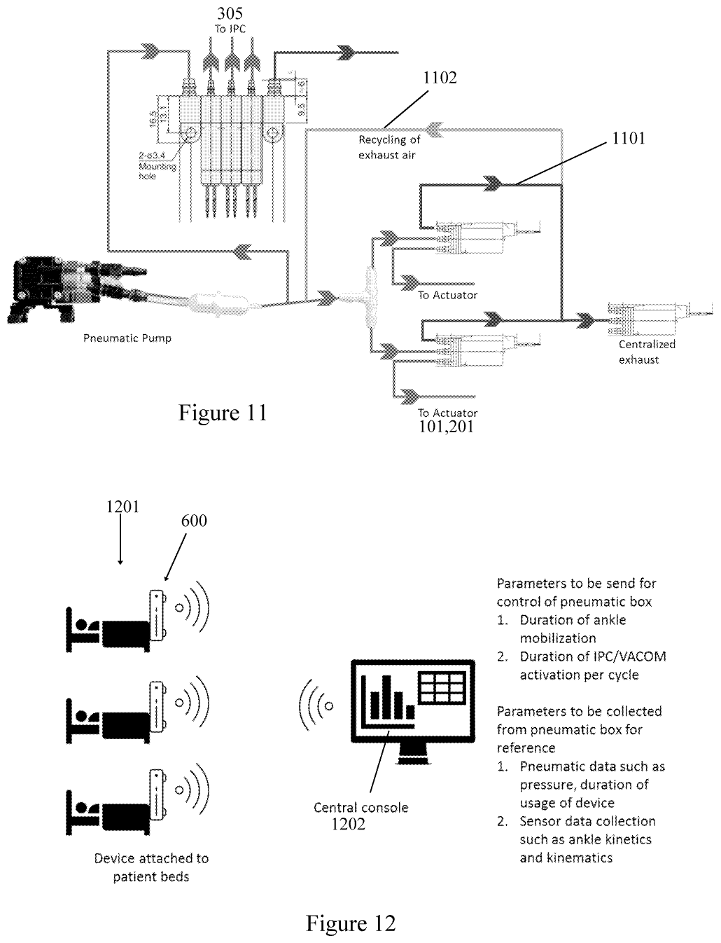

FIG. 11 illustrates the concept of pneumatic pressure recycling where positive exhaust air pressure from the extension actuator assemblies 410 is channeled back to the pneumatic line for inflating of the IPC device 305, which operates at lower air pressures. This is possible during alternate control of the rehabilitation device 300 and the IPC device 305. By recycling positive exhaust air pressure, this reduces total power consumption. At the same time, operation of the VACOM device 600 is quieter as exhaust air from the extension actuator assemblies 410 are not released into the surrounding environment.

The present invention includes the implementations of combination devices, when many bed-ridden patients use these VACOM devices 600 in a common ward environment.

As shown in FIG. 12, multiple VACOM devices 600, such as the assisted-ankle rehabilitation device 300 and the IPC devices 305, are connected to separate patients, in step 1201. A central console 1202 operable to control separate sets of the pneumatic VACOM devices 600 allows a single user to not only control the device parameters but to gather data from all the connected VACOM devices located in a common ward. The data can be transmitted wirelessly across the VACOM devices to remove the need for extended cables. The data can either be stored in real-time on the central console 1202 or can be pulled out from the connected pneumatic control boxes 601 when needed by the hospital users, such as the nurses or therapists.

In the above, the VACOM system is described for ankle rehabilitation. In another embodiment, it is possible that the VACOM system is adaptable for wrist rehabilitation. For example, an assisted-wrist rehabilitation device is also provided, which operates according to similar principles of the above assisted-ankle rehabilitation device 300. In addition, a series of compression devices for forearm rehabilitation are also provided, which operate according to similar principles of the above IPC device 305.

Although various aspects and embodiments of the present invention have been described above, it should be noted that the scope of the invention is by no means limited to the exemplary embodiments described above. The description of the exemplary embodiments of the present invention merely serves to aid in the understanding of the principle underlying the present invention. Thus, the present invention is not to be construed as being limited to the illustrated embodiments. Many changes, modifications, variations and combinations of variations disclosed in the description and drawings thereof could be made to the present invention without departing from the scope of the present invention. For example dorsiflexing and plantarflexing of the wrist or ankle, a single extension actuator assembly enclosed in one actuator pouch may be used, instead of using a pair of extension actuator assemblies as described above.

What is claimed is:

1. A soft robotic device for limb rehabilitation, comprising:
an extension actuator disposed in an actuator pouch;
braces for coupling two ends of the actuator pouch across a joint of a limb;
a sensor for detecting movement at the joint of the limb; and
a controller to receive input from the sensor and to output a signal to actuate the extension actuator to dorsiflex or plantarflex the joint.

2. The soft robotic device according to claim 1, wherein the limb is an upper limb or a lower limb.

3. The soft robotic device according to claim 1, wherein the extension actuators are inflatable by pneumatic pressure.

4. The soft robotic device according to claim 1, wherein the sensor is configured by an inertial measurement unit (IMU) sensor which has multiple axes for joint kinematics and kinetics sensing.

5. The soft robotic device according to claim 1, wherein the sensor is configured by a load cell which can measure the load applied to the joint according to joint stiffness.

6. The soft robotic device according to claim 1, further comprising an intermittent pneumatic compression (IPC) device which is attachable onto an arm muscle or a calf muscle, wherein the IPC is operable to minimize deep vein thrombosis or pulmonary embolism.

7. A soft robotic device for limb rehabilitation, comprising:
two extension actuators disposed side-by-side in an actuator pouch;
a sensor with a plurality of states based on a respective plurality of movement phases of a joint at the limb;
a controller in communication with the sensor to receive input from the sensor and to output signals to actuate the two extension actuators; and
braces for coupling two ends of the actuator pouch across the joint at the limb;
wherein the soft robotic device is operable to perform one of the following:
when both extension actuators are simultaneously inflated to perform joint dorsiflexion;
when both extension actuators are simultaneously deflated to perform joint plantarflexion; or
when either extension actuator is inflated while the other is deflated to perform joint eversion or inversion.

8. The soft robotic device according to claim 7, wherein the limb is an upper limb or a lower limb.

9. The soft robotic device according to claim 7, wherein the extension actuators are inflatable by pneumatic pressure.

10. The soft robotic device according to claim 7, wherein the sensor is configured by an inertial measurement unit (IMU) sensor which has multiple axes for joint kinematics and kinetics sensing.

11. The soft robotic device according to claim 7, wherein the sensor is configured by a load cell which can measure the load applied to the joint according to joint stiffness.

12. The soft robotic device according to claim 7, further comprising an intermittent pneumatic compression (IPC) device which is attachable onto an arm muscle or a calf muscle, wherein the IPC is operable to minimize deep vein thrombosis or pulmonary embolism.

13. A kit for limb rehabilitation, comprising:
a soft robotic device according to claim 12;
a pump for selectively inflating and deflating an extension actuator or an intermittent pneumatic compression (IPC) device;
a control box for controlling the pump;
a sensor for monitoring movements of a joint at the limb;
a pouch to contain the extension actuator;
a brace connectable at a foot or a hand; and
a brace connectable at a knee or an elbow;
wherein the soft robotic device is configured to synchronize inflation or deflation of the extension actuator with the IPC device to perform joint rehabilitation exercises.

14. The kit according to claim 13, wherein a series of IPC devices are arranged at the calf for lower limb rehabilitation.

15. The kit according to claim 13, wherein the soft robotic device and the IPC devices are controllable independently.

16. A system for limb rehabilitation, comprising:
a kit of components or kits thereof according to claim 13; and
a central console unit operable to receive data from each kit of components or kits, wherein the central console unit is operable to control each of the kit individually or together.

17. The system according to claim 16, wherein the IPC devices are operable intermittently and sequentially moving away from the lower limb.

18. The system according to claim 16, wherein the extension actuators or IPC devices are made of flexible elastomers, fabrics, textiles, or any combinations thereof.
